(19) United States
(12) Patent Application Publication
(10) Pub. No.: US 2019/0219226 A1
(43) Pub. Date: Jul. 18, 2019

(54) ABSORBENT PADDING FOR LIQUID SOLUTIONS AND HYDROCARBONS

(71) Applicant: Tiger Mats, LLC, Gonzales, LA (US)

(72) Inventor: Henri Jackson, Gonzales, LA (US)

(73) Assignee: Tiger Mats, LLC, Gonzales, LA (US)

(21) Appl. No.: 16/251,061

(22) Filed: Jan. 17, 2019

Related U.S. Application Data
(60) Provisional application No. 62/618,219, filed on Jan. 17, 2018.

(51) Int. Cl. F16N 31/00; B32B 5/26; B32B 5/02; B32B 15/14; B32B 15/18

(52) U.S. Cl. CPC F16N 31/006; B32B 5/26; B32B 5/022; B32B 15/14; B32B 15/18; B32B 2262/0253; B32B 2307/73; B32B 2307/72; B32B 2307/726; B32B 2262/062; B32B 2471/04

(57) ABSTRACT

The present disclosure provides for a crude oil sorption padding for liquid hydrocarbons. The device includes a first nonwoven outer layer of polypropylene material and a second nonwoven outer layer of polypropylene material. A composite core layer disposed between the outer layers, the core layer made from nonwoven cotton and coconut husk.

### CROSS REFERENCE TO RELATED APPLICATIONS

This application claims the benefit of U.S. Provisional Application No. 62/618,219, filed on Jan. 17, 2018, which is incorporated herein by reference.

### BACKGROUND OF THE INVENTION

### Field of the Invention

The present invention generally relates to the field of absorbent padding. More particularly, the invention relates to a crude oil sorption padding for liquid hydrocarbons.

### Description of the Related Art

It has been proposed to employ drip-catching mats which are principally designed for use beneath motor vehicles. For example, when a motor vehicle is at rest there is a tendency for it to leak oil, grease, or coolant onto the garage floor. In extreme cases, not only can this become very messy but can present a hazard to persons walking across the floor and accidentally slipping on the drippings.

In the field of spill cleanup, absorbent matting has been a generally viable part of cleanup solution for over 30 years. There are absorption products designed for spills and cleanup purposes in many industries that utilize liquid products as a routine portion of their daily operations. Absorbent materials are commonly utilized in automotive, manufacturing, petroleum and petrochemicals, food services, industrial, heavy equipment, marine, and any other industry that utilizes materials with a propensity to spill. At times, oil spills can be relatively large and require an enormous amount of absorbent material for cleanup.

U.S. Pat. No. 4,798,754 issued to Tomek discloses a lightweight, disposable absorbent mat that is adapted for placement beneath a motor vehicle or machine to catch oil, grease and other drippings and comprises a generally rectangular base layer which is made up of an oil-impervious material, and a plurality of upper, oil-absorbent plies that are interconnected to one another and superimposed on the base layer, the plies being made up of a highly absorbent paper or cellulose material. The plies of paper material are interconnected at spaced intervals and may be covered with an upper plastic layer which is perforated to permit any drippings to pass through the upper layer into the absorbent plies, the upper layer having an outer peripheral edge or edges sealed to the outer peripheral edges of the bottom layer to form a moisture barrier around the sides of the absorbent plies; and stiffener frame members may be interposed between the outer peripheral edges of the upper and base layers.

U.S. Patent Application Publication No. 2007/0207533 by Callahan discloses a portable, disposable device for the collection and bacteriological decomposition of liquid hydrocarbons including a pillow containing at least one member of the group consisting of (i) kenaf fibers/particles and (ii) a mixture of (a) natural, synthetic and/or oleophilic fibers/particles and (b)(i) one or more species of fungi selected from the group consisting of chaetonium indicum, chaetonium funicola, geotrichum candidum, macrophomina phaseolina, and trichoderma harziamum, and/or (b)(ii) one or more species of bacteria selected from the group consisting of bacillus subtillis, bacillus cereus sub group A and paenibacillus validus. The pillow may be quilted or otherwise constructed to define a plurality of chambers each containing the kenaf fibers/particles and/or the mixture of fibers/particles, fungi and/or bacteria. The device may further include a liquid impermeable pillow housing defining an opening to allow the liquid hydrocarbon to come into contact with the pillow. The pillow may define inter-connected channels for directing the flow of liquid hydrocarbons away from a contact point to evenly distribute the liquid hydrocarbons throughout the pillow. The upper and lower surfaces of the absorbent pillow may be constructed of different density fabric(s) and the pillow may define a sealed deflection area to further enhance the distribution of the liquid hydrocarbon throughout the pillow. A method of using the device includes the steps of: obtaining the device; placing the device proximate to a source of the liquid hydrocarbon and bringing the liquid hydrocarbon into contact with the device.

U.S. Pat. No. 5,730,558 issued to Holland discloses a device for collection and containment of spilled or leaked liquid hydrocarbons that absorbs pollutants that come into contact with the device. The absorbed material is solidified within the pillow into a rubber-like mass. An impermeable layer of material may be utilized in forming the bottom layer of the outer envelope of the device to retain accumulated hydrocarbons within the pillow while further allowing the contaminants to disperse throughout the device for absorption and solidification. The impermeable layer prevents spilled or leaked hydrocarbons from contaminating the surface below the device. The consolidated mass is easily retrieved and handled for disposal. A variety of options may be utilized in disposing of the spent device, including recycling the rubber-like mass as a component of tar-like materials, such as asphalt. The solidified hydrocarbons will not leech when exposed to pressure limits used to determine landfill suitability.

U.S. Pat. No. 5,588,785 issued to Holland discloses a device for collection and containment of spilled or leaked liquid hydrocarbons absorbs pollutants that come in contact. The absorbed material is solidified within the pillow into a rubber-like mass. An impermeable layer of material may be utilized in forming the bottom layer of the outer envelope of the device to retain accumulated hydrocarbons within the pillow while further allowing the contaminants to disperse throughout the device for absorption and solidification. The impermeable layer prevents spilled or leaked hydrocarbons from contaminating the surface below the device. The consolidated mass is easily retrieved and handled for disposal. A variety of options may be utilized in disposing of the spent device, including recycling the rubber-like mass as a component of tar-like materials, such as asphalt. The solidified hydrocarbons will not leach when exposed to pressure limits used to determine landfill suitability.

U.S. Pat. No. 5,462,785 issued to Holland discloses a device for collection and containment of spilled or leaked liquid hydrocarbons absorbs pollutants that come in contact. The absorbed material is solidified within the pillow into a rubber-like mass. The consolidated mass will float indefinitely and is easily retrieved and handled for disposal. The solidified hydrocarbons will not leech when exposed to pressure limits used to determine landfill suitability.

U.S. Pat. No. 5,645,378 issued to Holland discloses a device for collection and containment of spilled or leaked liquid hydrocarbons absorbs pollutants that come in contact. The absorbed material is solidified within the pillow into a rubber-like mass. An impermeable layer of material may be utilized in forming the bottom layer of the outer envelope of the device to retain accumulated hydrocarbons within the pillow while further allowing the contaminants to disperse throughout the device for absorption and solidification. The impermeable layer prevents spilled or leaked hydrocarbons from contaminating the surface below the device. The consolidated mass is easily retrieved and handled for disposal. A variety of options may be utilized in disposing of the spent device, including recycling the rubber-like mass as a component of tar-like materials, such as asphalt. The solidified hydrocarbons will not leech when exposed to pressure limits used to determine landfill suitability.

U.S. Patent Application Publication No. 2005/0284704 by Hernandez discloses a drip mat. The drip mat is a durable, modular fluid collection mat that rests on the ground in high-traffic areas where vehicles move slowly or stop for extended periods of time. The mat has at least one collection block that has a floor and at least one sidewall extending around the periphery of the floor to define a well for collecting fluids that drip from the vehicle. A grill is disposed over the well. The floor has sloping panels that direct the fluids to drain holes, where the fluids can be drawn out of the mat by an expandable container that is connected to the drain holes by a flexible hose. By connecting multiple straight and curved collection blocks together, the mat can cover different size areas. The mat has ramps on either end of the collection block(s) to allow vehicles to ride upon it, and has areas for logos and advertising.

U.S. Patent Application Publication No. 2002/0108956 by Doh discloses an oil drip mat having a panel with a peripheral margin and a sump. The mat also includes a removable oil absorbent pad positioned within the sump. The top surface of the peripheral margin slopes downwardly from the outer edge of the margin toward the sump so that fluids dripping upon the top surface of the margin are gravitationally drawn into the sump wherein they are absorbed by the pad.

U.S. Pat. No. 4,704,110 issued to Raykovitz, et al. discloses an absorbent article comprising an elongated absorbent pad having a body facing surface and a garment facing surface, a portion of the garment facing surface being coated with a hot melt pressure sensitive adhesive composition comprising a styrene-butadiene-styrene block or multi-block copolymer containing 35 to 55 parts styrene per 100 parts copolymer, a tackifying resin, a naphthenic or paraffinic oil, and an antioxidant.

European Patent No. EP 0 786 496 B1 issued to Sugimoto discloses biodegradable plastics which have an enhanced rate of biodegradability from the addition of compressed powdered plant fiber such as, for example, fiber from coconut mesocarp. However, the fibers within the mesocarp are used currently only to make string and rope and are not generally used for anything else.

The U.S. Patents and U.S. Patent Application Publications listed above are hereby incorporated by reference.

Over the years, various devices have been made to assist people with the clean up of crude oil and other fluid spills. However, such commonly known devices are of complex construction, largely inefficient in operation, and often result in ineffective cleanup operations. For example, while cellulose-based materials such as wood pulp fibers are relatively inexpensive, they are hydrophilic and attractive to oil, or oil-philic, and therefore absorb both oil and water readily. Accordingly, when cellulose-based material is used to clean an oil spill, it tends to absorb both oil and water and thus a significant portion of the cellulose-based material becomes saturated with water or other aqueous solutions such as saline. This inhibits oil spill cleanup.

Additionally, conventional absorbent materials that are made primarily of plastic that never biodegrade create a negative effect on the environment.

While these conventional units may be partly suitable for the particular purpose employed, they would not be as suitable for the purposes of the present invention as disclosed hereafter.

Accordingly, there is a need for a biodegradable super-absorbent mat pad capable of absorbing crude oil that better repels water and is better for the environment.

As disclosed in this application, the inventor has discovered novel and unique devices and methods for efficient crude oil sorption, which exhibit superlative properties without being dependent on inefficient, expensive or complex components.

Embodiments of the present invention provide for devices and methods and disclosed herein and as defined in the annexed claims which provide for improved crude oil sorption for liquid hydrocarbons. Embodiments of the invention disclosed herein further aid in environmental sustainability, improved biodegradability, and carbon footprint reduction.

### SUMMARY OF THE INVENTION

It is one prospect of the present invention to provide one or more novel devices of simple but effective construction which can be applied to many environments to efficiently and effectively absorb liquid solutions and hydrocarbons.

The following presents a simplified summary of the present disclosure in a simplified form as a prelude to the more detailed description that is presented herein.

Therefore, in accordance with embodiments of the invention, there is provided a crude oil sorption padding for absorbing liquid hydrocarbons from a solid or liquid surface and safely disposing of such liquid hydrocarbons. In one embodiment, the padding has a first nonwoven outer layer composed of a polypropylene material and a second nonwoven outer layer composed of polypropylene material, which contain a composite core layer disposed between the two nonwoven outer layers.

The composite core layer is composed of coconut husk suspended within the fibers of a nonwoven cotton. In such preferred embodiment, the nonwoven cotton is unmatured cotton having a waxy surface. In one embodiment, the composite core layer comprises a plurality of layers of combed cotton, which forms an unwoven cotton batten. The composite core layer is characterized as hydrophobic.

In one embodiment, the nonwoven cotton of the composite core layer is unmatured cotton having a waxy surface, which is characterized as hydrophobic. The composite core layer when soaked with liquid oil is characterized as having a lower specific density than water, wherein the oil-soaked padding will float on water.

In yet another embodiment, the composite core layer is characterized as water repellant, oil absorbent. The padding has a plurality of stitched seams connecting the first outer layer to the second outer layer and enclosing the composite core layer therebetween. The plurality of stitched seams forms a diamond pattern forming side-by-side pockets within the padding for the containment of oil.

In a preferred embodiment, a crude oil sorption boom for liquid hydrocarbon containment has a first nonwoven outer layer of polypropylene material and a composite core layer disposed between said outer layer. The core layer contains nonwoven cotton and coconut husk, wherein said layers form an elongated body having a first end opposite a second end. The first end has stitching enclosing the first end and the second end has stitching enclosing the second end, which creates an enclosed tube.

In another embodiment, the nonwoven cotton is unmatured cotton having a waxy surface.

In yet another embodiment, the composite core layer comprises a plurality of layers of combed cotton, which forms an unwoven cotton batten. The composite core layer is characterized as hydrophobic.

In yet another embodiment, the nonwoven cotton is unmatured cotton having a waxy surface, wherein the composite core layer is characterized as hydrophobic. The composite core layer when soaked with liquid oil is characterized as having a lower specific density than water. The composite core layer having the lower specific density than water will then cause the oil-soaked boom to float on water.

In yet another embodiment, the composite core layer is characterized as water repellant and oil absorbent.

In a preferred embodiment, an oil sorption pillow for liquid hydrocarbons includes a first nonwoven outer layer of polypropylene material, a second nonwoven outer layer of polypropylene material, and a composite core layer disposed between the outer layers. The core layer is made from nonwoven cotton and coconut husk.

In another embodiment, the nonwoven cotton is unmatured cotton having a waxy surface.

In one embodiment, the composite core layer comprises a plurality of layers of combed cotton, and the combed cotton forms an unwoven cotton batten.

In yet another embodiment, the composite core layer is characterized as hydrophobic.

In an embodiment, the nonwoven cotton is unmatured cotton having a waxy surface, wherein the composite core layer is characterized as hydrophobic.

In one embodiment, the composite core layer when soaked with liquid oil is characterized as having a lower specific density than water.

In an embodiment, the oil-soaked padding will float on water.

In yet another embodiment, the composite core layer is characterized as water repellant, oil absorbent.

In an embodiment, a plurality of stitched seams connects the first out layer to the second outer layer and encloses the composite core layer therebetween.

In accordance with embodiments of the invention, there is provided an oil sorption oil drum lid for liquid hydrocarbons having a nonwoven top layer made from a polypropylene textile material and a nonwoven bottom layer made from a polypropylene textile material. A composite core layer is disposed between the top layer and the bottom layer. The composite core layer is made from nonwoven cotton and coconut husk, wherein the top layer, the composite core layer and the bottom layer form an oil sorption pad having a round planar body. The planar body of the pad defines a first opening and a second opening adapted for the guided passage of oil through said pad when fixed atop an oil drum. The round planar body is preferably 22 inches in diameter.

In one embodiment, the composite core layer includes a plurality of layers of combed cotton forming an unwoven cotton batten.

In another embodiment, a round planar steel layer is fixed beneath the nonwoven bottom layer. The steel layer has a first bung hole in alignment with the first opening and a second bunghole in alignment with the second opening.

In yet another embodiment, the nonwoven cotton is unmatured cotton having a waxy surface, wherein the composite core layer is characterized as hydrophobic.

In another embodiment, the composite core layer when soaked with liquid oil is characterized as having a lower specific density than water.

In yet another embodiment, the oil-soaked lid will float on water.

In one embodiment, the composite core layer is characterized as water repellant, oil absorbent.

This invention also encompasses a method for cleaning an oil spill on a body of water having a surface, wherein the layer of oil rests on the surface of the body of the water. The method includes the steps of, firstly, placing a boom 114 of the present invention on the layer of oil so that the first exposed outer layer 102 of the boom 114 contacts the oil, which rests on the surface of the body of water, and secondly, removing the boom 114 from the body of water. The used boom 114 can then be discarded. Alternatively, the oil can be removed from the boom 114, and the salvaged boom 114 can be reused.

Through embodiments of the invention disclosed herein, the oil sorption padding 100 more efficiently and effectively than conventional absorbent mats, wipes up spilled diesel fuel from tug boats and barges which plow through the waters of the U.S.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is an exploded front right perspective view of an exemplary crude oil sorption padding in accordance with embodiments of the invention;

FIG. 2 is an exploded front right perspective view of an exemplary crude oil sorption padding in accordance with embodiments of the invention;

FIG. 3 is front elevation view partially cut away of an exemplary crude oil sorption boom in accordance with embodiments of the invention;

FIG. 4 is a front right perspective view partially cut away of an exemplary crude oil sorption pillow in accordance with embodiments of the invention; and

FIG. 5 is a front perspective view of an exemplary crude oil sorption oil-barrel drum lid in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

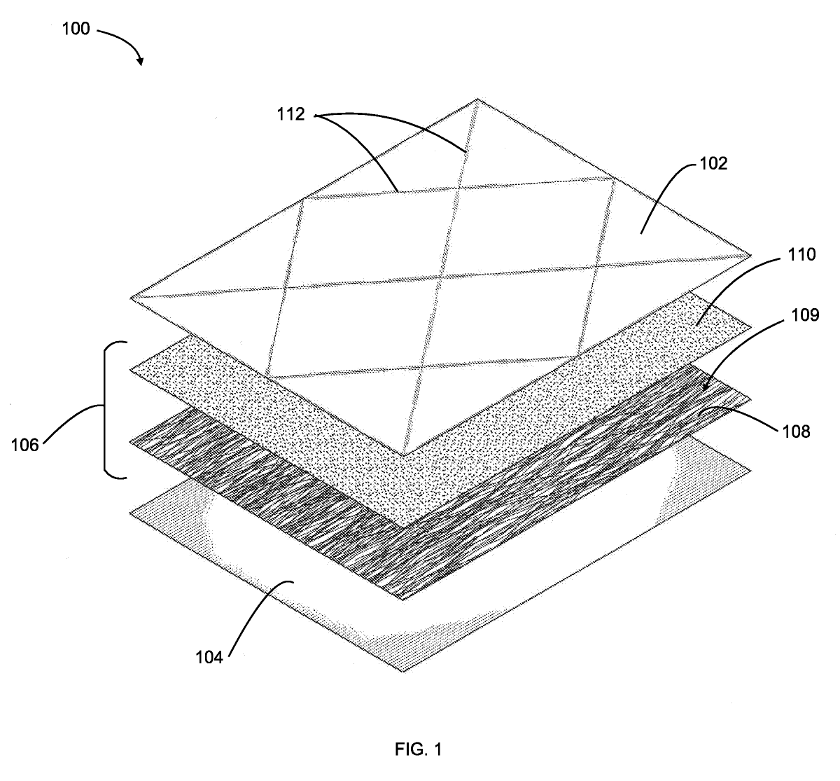

Referring initially to FIGS. 1-5, the basic constructional details and principles of operation of one embodiment of a crude oil sorption padding for liquid hydrocarbons 100 according to a preferred embodiment of the present invention will be discussed. Referring to the preferred embodiment shown in FIG. 1, a crude oil sorption padding for liquid hydrocarbons 100 preferably includes a first nonwoven outer layer of polypropylene material 102 and a second nonwoven outer layer of polypropylene material 104. A composite core layer 106 is preferably disposed between the outer layers 102 and 104. In a preferred embodiment, the core layer 106 is constructed of nonwoven cotton 108 and coconut husk 110, for example. Preferably, coconut husk fibers 110 are suspended within the fibers of nonwoven combed raw cotton 108 during the process used to form the composite core layer 106.

In a preferred embodiment, the nonwoven cotton 108 is unmatured cotton having a waxy surface. Preferably, the composite core layer 106 is made from a plurality of layers of combed cotton forming an unwoven cotton batten. The raw, immature cotton 108 has smaller diameter fibers than mature processed cotton and thereby increase the rate of oil sorption of the inner composite core layer 106. The combination of the absorbent matting 106 infused with coconut husk 110 and raw cotton 108 creates a pad material capable of greater absorbency than any of the individual components used without the others. Unlike most conventional oil or chemical spill products that have hazardous materials, which, may be classified as having carcinogens, such as silica, the crude oil sorption padding 100 is not hazardous to humans or the environment. Embodiments herein provide for a padding 100 designed to provide maximum absorbency of liquids such as oils, greases, chemicals, hazardous chemicals, solvents, coolants, flammable liquids, alcohols, aqueous solutions, glycol, hydrocarbons, acids, bases, and unknown liquids.

The first and second exposed outer layers 102 and 104, although hydrophobic, are porous and allow the passage of liquids such as crude oil and diesel fuel oil. In embodiments of the invention, suitable first and second exposed outer layers 102 and 104 comprise, for example, polypropylene, polyethylene or polystyrene, polyesters such as polyethylene terephthalate, and/or polyamides such as nylon. Polypropylene is particularly desirable because of the combinations of strength, hydrophobicity and low cost. Preferably the first and second outer layers 102 and 104 remain hydrophobic, because they are not treated with a surfactant, which would otherwise increase the hydrophilicity or wettability of the material.

In one embodiment, the composite core layer 106 is characterized as hydrophobic.

In one embodiment, the nonwoven cotton 108 is unmatured cotton having a waxy surface 109 and the composite core layer 106 is characterized as hydrophobic.

In one embodiment, the composite core layer 106 is characterized as having a lower specific density than water when soaked with liquid oil. Preferably, the oil-soaked padding floats on water.

In one embodiment, the composite core layer 106 is characterized as water repellant and oil absorbent.

In a preferred embodiment, the oil sorption padding 100 includes a plurality of stitched seams 112 connecting the first outer layer 102 to the second outer layer 104 and enclosing the composite core layer 106 therebetween.

In one embodiment, the stitched seams 112 form a diamond pattern forming side-by-side pockets within said padding for the containment of oil, as illustrated in FIG. 1. The diamond pattern provides an increased area for the husk to expand. In one embodiment, the mat is 87% biodegradable.

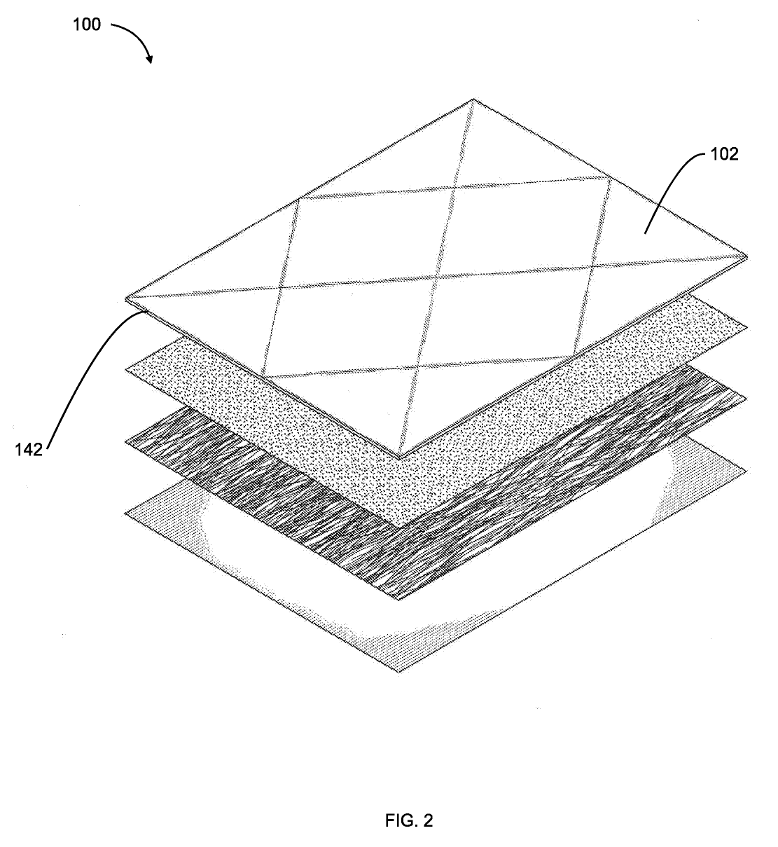

Referring to the preferred embodiment illustrated in FIG. 2, the mat 100 has a lip 142 around the perimeter that can be folded upwards to form a shallow dish like configuration. The lip 142 allows the mat 100 to more effectively contain or localize a spill and increases the amount of liquid absorbed. Preferably, the lip 142 will be constituted of a substance that enables the mat 100 material to be elevated around the parameter of the mat 100.

Preferably, the mats 100 are constructed with environmentally friendly materials, such as coconut husk and unrefined cotton. In one embodiment, the mats 100 are sized as 15 in×19 in or 6 in×7 in, 3 in×42 in and 3 in×12 in socks, or 22 in rounds to accommodate different shapes or sizes of spills. Used mats 100 can be run through a mechanical wringer, for example, to recover the entrapped liquids for recycle and/or to reduce the cost of disposal. Mats that have been run through the wringer can also be reused, although their absorbency may be significantly reduced. In one embodiment, the thickness of the mat 100 is 2 mm. In one embodiment, the composition of the mat 100 is 12.5% polypropylene shell 102, 104 and 87.5% immature cotton 108 and coconut coir/husk core 110, enabling the mat 100 to be mostly biodegradable. In one embodiment, the composition of the mat 100 is denim shell 102, 104 and immature cotton 108 and coconut coir/husk core 110, enabling the mat 100 to be potentially totally biodegradable and compostable.

In one embodiment, the mat 100 pad material is multi-layered using 25% recycled and 50% fully biodegradable, sustainable components. Some embodiments disclosed herein are 48% more absorbent than conventional absorbent devices.

In one embodiment, a pallet of 200 units of 6 in×7 in mats 100 can absorb up to 9,600 oz. of crude oil representing almost 2 full barrels of oil per pallet. Through embodiments disclosed herein, the pad 100 is capable of absorbing 2.5 times more fluids than conventional oil absorbing pads.

In one embodiment, the mats 100 are 15 in×19 in mats comprising a nonwoven, melt blown polypropylene layer weighing 2.2 oz (350 gsm), coconut peat weighing 2.1 oz (60 gsm), and raw organic needle punched cotton at 0.8 oz (22.1 gsm), wherein the three layers 102, 104, and 106 are diamond stitched in front and back, measured at 2 mm thick, for a total weight of 5.2 oz (146.4 gsm) per each completed mat.

In one embodiment, the mats 100 are 7 in×9 in, mats comprising a nonwoven, melt blown polypropylene layer weighing 1.1 oz (175 gsm), coconut peat weighing 1.05 oz (30 gsm), and raw organic needle punched cotton at 0.4 oz (11.05 gsm), wherein the three layers 102, 104, and 106 are diamond stitched in front and back, preferably measured at 2 mm thick, for a total weight of 2.6 oz (73.2 gsm) per each completed 7 in×9 in mat.

In one embodiment, the cotton husk 110 is 100% raw organic needle punched cotton.

In one embodiment, the composition of mat 100 is denim, recycled fibers, unprocessed cotton, coco peat, and polylactic acid (PLA) for adhesive quality.

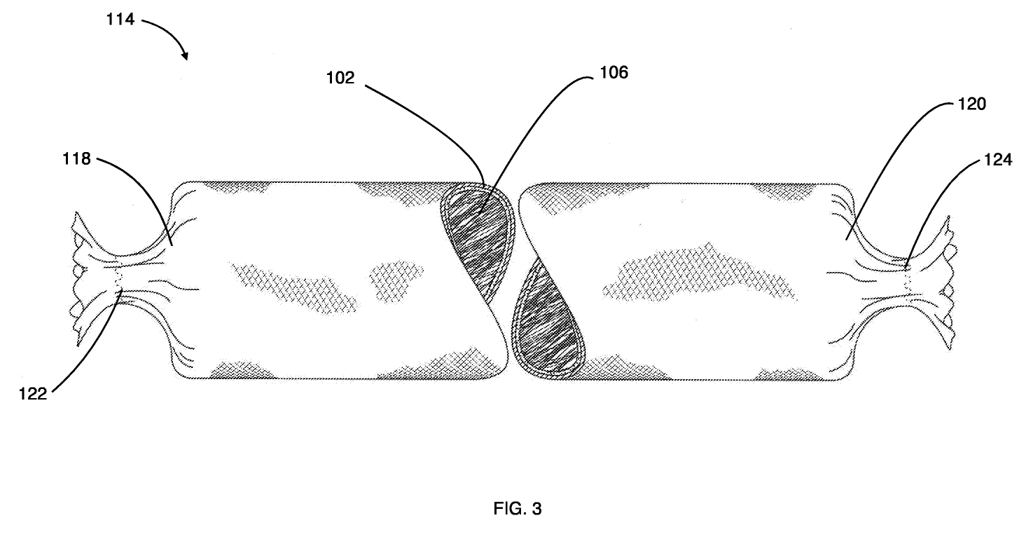

Referring to FIG. 3, in a preferred embodiment of the invention, a crude oil sorption boom for liquid hydrocarbons containment 114 preferably includes a first nonwoven outer layer 102 of polypropylene material and a composite core layer 106 is disposed within the outer layer 102. The core layer 106 preferably includes nonwoven cotton 108 and coconut husk 110. The layers 102 and 106 form an elongated body 116 having a first end 118 opposite a second end 120. A stitching 122 preferably encloses the first end 118. A stitching 124 preferably encloses the second end 120.

In one embodiment, the nonwoven cotton 108 is preferably unmatured cotton having a waxy surface 109. The boom 114 is useful in agricultural and food processing industries, for example. The cylindrical shape of the boom 114 allows it to be applied for a practical use in a variety of spaces, including long term fluid collection or containment. The greater surface area of the cylindrical shape of the boom 114 can provide for an increase in absorption of liquid.

In one embodiment, the composite core layer 106 is made from a plurality of layers of combed cotton forming an unwoven cotton batten.

In one embodiment, the composite core layer 106 is characterized as hydrophobic.

In one embodiment, the nonwoven cotton 108 is preferably unmatured cotton having a waxy surface 109 and the composite core layer 106 is characterized as hydrophobic.

In one embodiment, the composite core layer 106 is characterized as having a lower specific density than water when soaked with liquid oil.

In one embodiment, the oil-soaked boom 114 will float on water.

In one embodiment, the composite core layer 106 is characterized as water repellant, oil absorbent.

The boom 114 is particularly useful to contain the periphery of an oil spill. Preferably, a length of the boom 114 is placed about the periphery of an oil spill and contains the oil spill while absorbing oil in the same manner as described with regard to the embodiments illustrated in FIGS. 1 and 2 and described above. The boom 114 will float on water or saline even when saturated with oil, because oil is lighter than water, so that the absorbent article will be easy to locate and remove from the body of water once the clean up is completed.

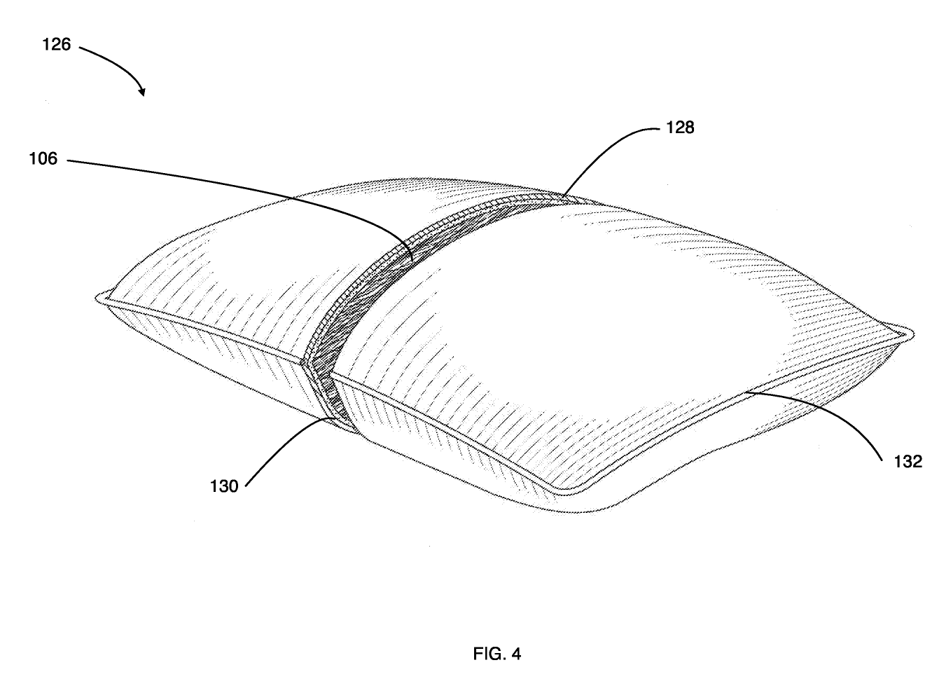

Referring to FIG. 4, in a preferred embodiment of the invention, an oil sorption pillow for liquid hydrocarbons 126 includes a first nonwoven outer layer of polypropylene material 128 and a second nonwoven outer layer of polypropylene material 130. Preferably, a composite core layer 106 is disposed between said outer layers 128 and 130, said core layer 106 comprising nonwoven cotton 108 and coconut husk 110. A seam 132 connects the outer layers 128 and 130, enclosing the composite core layer 106 therebetween. Preferably, the composite core layer 106 of the pillow 126 is configured to have a greater amount of material than mat 100, allowing for greater absorption of liquids when a larger amount of liquid needs to be absorbed.

In one embodiment, the nonwoven cotton 108 is unmatured cotton having a waxy surface 109.

In one embodiment, the composite core layer 106 includes a plurality of layers of combed cotton, said combed cotton forming an unwoven cotton batten.

In one embodiment, the composite core layer 106 is characterized as hydrophobic.

In one embodiment, the nonwoven cotton 108 is unmatured cotton having a waxy surface 109, wherein the composite core layer 106 is characterized as hydrophobic.

In one embodiment, the composite core layer 106 is characterized as having a lower specific density than water when soaked with liquid oil.

In one embodiment, the oil-soaked pillow 126 will float on water.

In one embodiment, the composite core layer 106 is characterized as water repellant, oil absorbent.

In one embodiment, the oil sorption pillow 126 further includes a plurality of stitched seams 112 connecting the first outer layer 102 to the second outer layer 104 and enclosing the composite core layer 106 therebetween.

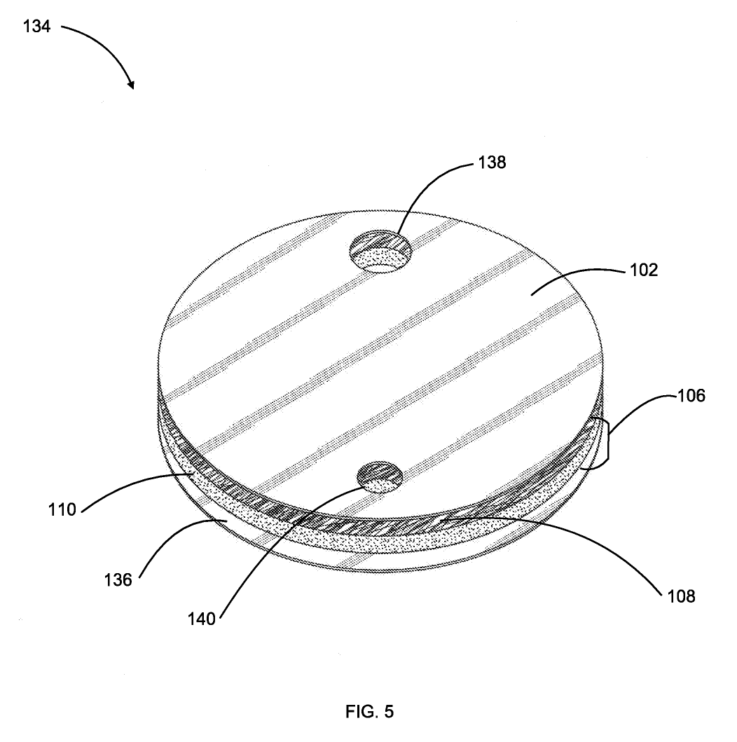

Oil drums (barrels) are conventionally available as either open head or tight head. Open head drums have a fully removable cover secured with a bolt or lever lock ring closure. Tight head drums, also known as closed head, have a secured, non-removable top and are typically used with lower viscosity liquids. A cover is the lid or top to open head drums. Disclosed herein is an oil sorption oil sorption oil drum lid 134 for use with carbon steel or stainless steel oil drums as illustrated in the preferred embodiment of the invention in FIG. 5. Then oil sorption oil drum lid 134 for liquid hydrocarbons has a nonwoven top layer 102 made from a polypropylene textile material and a nonwoven bottom layer 104 made from a polypropylene textile material. A composite core layer 106 is disposed between the top layer 102 and the bottom layer 104. The composite core layer 106 is made from nonwoven cotton 108 and coconut husk 110, wherein the top layer 102, the composite core layer 106 and the bottom layer 104 form an oil sorption pad 134 having a round planar body. The planar body of the pad defines a first opening 138 and a second opening 140 adapted for the guided passage of oil through said pad when fixed atop an oil drum. The round planar body is preferably 22 inches in diameter.

A first opening 138 and a second opening 140 are preferably configured to allow for access to openings in steel drums. For example, steel drums typically have two openings (bung holes) with flanges, 2 in and ¾ in in diameter, in the top of the container (or cover for open head drums) and openings 138 and 140 are sized accordingly. Preferably, the oil sorption oil-barrel drum lid for liquid hydrocarbons 134 prevents spilling or leaking from the contents inside of the barrel and absorbs foreign liquids and prevents unwanted liquids from entering the oil drum. As can be appreciated from the disclosure herein, the oil sorption oil drum lid 134 absorbs oil dripped or spilled from oil drum filling machines connected to the oil drum.

In one embodiment, the composite core layer 106 includes a plurality of layers of combed cotton 108 forming an unwoven cotton batten.

In another embodiment, a round planar steel layer 136 is fixed beneath the nonwoven bottom layer 108. The steel layer has a first bung hole in alignment with the first opening 138 and a second bunghole in alignment with the second opening 140.

In yet another embodiment, the nonwoven cotton 108 is unmatured cotton having a waxy surface, wherein the composite core layer 106 is characterized as hydrophobic.

In another embodiment, the composite core layer 106 when soaked with liquid oil is characterized as having a lower specific density than water.

In yet another embodiment, the oil-soaked lid 134 will float on water.

In one embodiment, the composite core layer 106 is characterized as water repellant, oil absorbent.

Embodiments of the invention are disclosed to provide a novel, efficient padding that is designed for maximum absorption of a wide variety of exemplary liquid products such as oils, greases, chemicals, hazardous chemicals, solvents, coolants, flammable fluids, alcohols, aqueous solutions, glycol, hydrocarbons, acids, and bases. For example, the pad can be constructed of commercially available absorbent pad material with the addition of cotton, coconut husk, and a lip (in some applications) placed inside the pad material to create a super absorbent material that enhances the absorbent properties of the three materials utilized in conjunction with one another. The combination creates a single pad capable of maximum absorbent properties.

A variety of commercially available absorbent padding intended for multiple uses, such as but not limited to, a multiple component absorbent padding designed to provide maximum absorbency of liquids such as, but not limited to, oils, greases, chemicals, hazardous chemicals, solvents, coolants, flammable fluids, alcohols, aqueous solutions, glycol, hydrocarbons, acids, bases, and unknown liquids.

Exemplary industries are oil and gas energy services, wholesale grocer packaging, and agriculture. Embodiments of the invention disclosed herein aid in sustainability, biodegradability, and carbon footprint reduction.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A crude oil sorption padding for liquid hydrocarbons comprising:
a first nonwoven outer layer of polypropylene material;
a second nonwoven outer layer of polypropylene material; and
a composite core layer disposed between said outer layers, said core layer comprising nonwoven cotton and coconut husk.

2. The oil sorption padding of claim 1, wherein the nonwoven cotton is unmatured cotton having a waxy surface.

3. The oil sorption padding of claim 1, wherein the composite core layer comprises a plurality of layers of combed cotton, said combed cotton forming an unwoven cotton batten.

4. The oil sorption padding of claim 1, wherein the composite core layer is characterized as hydrophobic.

5. The oil sorption padding of claim 1, wherein the nonwoven cotton is unmatured cotton having a waxy surface, wherein the composite core layer is characterized as hydrophobic.

6. The oil sorption padding of claim 1, wherein the composite core layer when soaked with liquid oil is characterized as having a lower specific density than water.

7. The oil sorption padding of claim 6, wherein the oil-soaked padding will float on water.

8. The oil sorption padding of claim 1, wherein the composite core layer is characterized as water repellant, oil absorbent.

9. The oil sorption padding of claim 1, further comprising a plurality of stitched seams connecting the first outer layer to the second outer layer and enclosing the composite core layer therebetween.

10. The oil sorption padding of claim 9, wherein the stitched seams comprise a diamond pattern forming side-by-side pockets within said padding for the containment of oil.

11. A crude oil sorption boom for liquid hydrocarbons containment comprising:
a first nonwoven outer layer of polypropylene material; and
a composite core layer disposed between within said outer layer, said core layer comprising nonwoven cotton and coconut husk, wherein said layers form an elongate body having a first end opposite a second end, wherein said first end comprises stitching enclosing said first end, wherein said second end comprises stitching enclosing said second end.

12. The oil sorption boom of claim 11, wherein the nonwoven cotton is unmatured cotton having a waxy surface.

13. The oil sorption boom of claim 11, wherein the composite core layer comprises a plurality of layers of combed cotton, said combed cotton forming an unwoven cotton batten.

14. The oil sorption boom of claim 11, wherein the composite core layer is characterized as hydrophobic.

15. The oil sorption boom of claim 11, wherein the nonwoven cotton is unmatured cotton having a waxy surface, wherein the composite core layer is characterized as hydrophobic.

16. The oil sorption boom of claim 11, wherein the composite core layer when soaked with liquid oil is characterized as having a lower specific density than water.

17. The oil sorption boom of claim 16, wherein the oil-soaked boom will float on water.

18. The oil sorption boom of claim 11, wherein the composite core layer is characterized as water repellant, oil absorbent.

19. An oil sorption pillow for liquid hydrocarbons comprising:
a first nonwoven outer layer of polypropylene material;
a second nonwoven outer layer of polypropylene material; and
a composite core layer disposed between said outer layers, said core layer comprising nonwoven cotton and coconut husk.

20. The oil sorption pillow of claim 19, wherein the nonwoven cotton is unmatured cotton having a waxy surface.

21. The oil sorption pillow of claim 19, wherein the composite core layer comprises a plurality of layers of combed cotton, said combed cotton forming an unwoven cotton batten.

22. The oil sorption pillow of claim 19, wherein the composite core layer is characterized as hydrophobic.

23. The oil sorption pillow of claim 19, wherein the nonwoven cotton is unmatured cotton having a waxy surface, wherein the composite core layer is characterized as hydrophobic.

24. The oil sorption pillow of claim 19, wherein the composite core layer when soaked with liquid oil is characterized as having a lower specific density than water.

25. The oil sorption pillow of claim 24, wherein the oil-soaked pillow will float on water.

26. The oil sorption pillow of claim 19, wherein the composite core layer is characterized as water repellant, oil absorbent.

27. The oil sorption pillow of claim 19, further comprising a plurality of stitched seams connecting the first out layer to the second outer layer and enclosing the composite core layer therebetween.

28. An oil sorption oil drum lid for liquid hydrocarbons comprising:
a nonwoven top layer comprising a polypropylene textile material;
a nonwoven bottom layer comprising a polypropylene textile material;
a composite core layer disposed between said top layer and said bottom layer, said composite core layer comprising nonwoven cotton and coconut husk, wherein said top layer, composite core layer and bottom layer form an oil sorption pad having a round planar body, wherein said planar body of the pad defines a first opening and a second opening adapted for the passage of oil through said pad when fixed atop an oil drum.

29. The oil sorption oil drum lid of claim 28, wherein the composite core layer comprises a plurality of layers of combed cotton, said combed cotton forming an unwoven cotton batten.

30. The oil sorption oil drum lid of claim 28, further comprising a round planar steel layer fixed beneath the nonwoven bottom layer, said steel layer having a first bung hole in alignment with the first opening, and said steel layer having a second bunghole in alignment with the second opening.

31. The oil sorption oil drum lid of claim 28, wherein the nonwoven cotton is unmatured cotton having a waxy surface, wherein the composite core layer is characterized as hydrophobic.

32. The oil sorption oil drum lid of claim 28, wherein the nonwoven cotton is unmatured cotton having a waxy surface, wherein the composite core layer is characterized as hydrophobic.

33. The oil sorption oil drum lid of claim 28, wherein the composite core layer when soaked with liquid oil is characterized as having a lower specific density than water.

34. The oil sorption oil drum lid of claim 33, wherein the oil-soaked lid will float on water.

35. The oil sorption oil drum lid of claim 28, wherein the composite core layer is characterized as water repellant, oil absorbent.
